(19) United States
(12) Patent Application Publication
(10) Pub. No.: US 2012/0169636 A1
(43) Pub. Date: Jul. 5, 2012

(54) TOUCHABLE SENSING MATRIX UNIT, A CO-CONSTRUCTED ACTIVE ARRAY SUBSTRATE HAVING THE TOUCHABLE SENSING MATRIX UNIT AND A DISPLAY HAVING THE CO-CONSTRUCTED ACTIVE ARRAY SUBSTRATE

(76) Inventor: Hung-Ta LIU, Chupei City (TW)

(21) Appl. No.: 13/336,721

(22) Filed: Dec. 23, 2011

(30) Foreign Application Priority Data
Dec. 31, 2010 (TW) 099147434

(51) Int. Cl. G06F 3/041

(52) U.S. Cl. 345/173

(57) ABSTRACT

The present invention relates to a touchable sensing matrix unit, a co-constructed active array substrate having the touchable sensing matrix unit and a display having the co-constructed active array substrate. The touchable sensing matrix unit is formed on the co-constructed active array substrate and has multiple first sensing and transmitting wires and multiple second sensing and transmitting wires. The first and second sensing and transmitting wires are conductive and cyclic, intersect to form an angle, and sandwich an insulation layer formed therebetween. The touchable sensing matrix unit has at least one set of wires of the co-constructed active array substrate and an improved design using the at least one set of wires.

### BACKGROUND OF THE INVENTION

1. Field of the Invention

The present invention relates to an active-array display having an integrated touch control function and more particularly to a touchable sensing matrix unit mounted on a co-constructed active array substrate, having lead wires including multiple first sensing and transmitting circuits and multiple second sensing and transmitting circuits angularly intersecting with each other, and being conductive and cyclic.

2. Description of the Related Art

High yield and accurate touch control of touch panels is attributable to advanced development of the touch panels. Touch panels can be classified into electromagnetic, resistive, capacitive, optical (infrared and SAW) types and the like.

To facilitate users' input, a light, thin and compact electronic product usually addresses a space-saving approach providing a touch panel stacked on a display screen thereof With reference to FIG. 25, a touch panel 91 is mounted on a flat panel display 90 through an adhesive layer 901 to constitute a flat panel display having a touch control function. However, being too thick is the drawback of such structural design and affects transmittance of the flat panel display 90.

To keep abreast with the increasingly demanded requirement for the touch control feature, manufacturers of touch panels or flat panel displays all start thinking of integrating touch panels in the production processes of flat panel displays so that flat panel displays can be truly touchable and keep original transmittance thereof.

With reference to FIGS. 26 and 27, a flat panel display having a resistive touch control function has a color filter substrate 92, multiple spacers 93, an upper transparent electrode layer 94, a TFT (thin-film transistor) array substrate 95 and a liquid crystal layer. The spacers 93 are formed on a bottom surface of the color filter substrate 92. The upper transparent electrode layer 94 is coated on the spacers 93. The TFT array substrate 95 has a dielectric layer 96, a protection layer 97 and a lower transparent conductive layer 98 sequentially formed on a top surface thereof The TFT array substrate 95 further has two metal pads 971 mounted on each pixel electrode zone to correspond to one of the spacers 93 of the color filter substrate 92. The liquid crystal layer is mounted between the color filter substrate 92 and the TFT array substrate 95.

A free end of each spacer 93 is not in contact with the lower transparent conductive layer 98 of the TFT array substrate 95. When the flat panel display is touched, a corresponding spacer 93 moves downwardly so that the upper transparent electrode layer 94 contacts and is electrically connected with the two metal pads 971. As the metal pads 971 are connected with the lower transparent electrode layer 98, power can be transmitted through the lower transparent electrode layer 98. Being a resistive thin film, the lower transparent electrode layer 98 is equivalent to a transparent and resistive thin film of the flat panel display. When the upper and lower transparent electrode layers 94, 98 meet at different positions of the flat panel display to result in a short circuit, different voltage values are received for determining coordinates of the touched position.

With reference to FIG. 28, an electromagnetic touch panel is structurally similar to the foregoing flat panel display and the difference lies in the electromagnetic sensing method. A color filter substrate 92′ has multiple lead wires 99a, 99b mutually intersected and respectively aligning in a first direction and a second direction for respectively transmitting exciting signals and sensing signals. By sending an exciting signal, using an electromagnetic pen and determining variation of a received sensing signal, coordinates of a position on the color filter substrate touched by the electromagnetic pen can thus be identified.

The foregoing conventional touch panels can be certainly integrated into the flat panel displays to realize thin touchable displays. However, the production processes and structures of the display devices must be altered. Once the production processes and structures of the display device are altered, challenges encountered first are nothing but lowered yield and higher production cost. As far as the resistive touch panel in FIGS. 26 and 27 is concerned, despite the measure of varying voltage values using the transparent electrode layer on the spacers to make point contact with the two metal pads, the spacers must be separated from the TFT array substrate. Additionally, each pixel electrode of the TFT array substrate further needs two metal pads, X-axis and Y-axis auxiliary circuits, thereby not only reducing a visible area of the pixel electrode but also making the production processes of the TFT array substrate complicated.

Moreover, pressure and deformation sensed at the center, edges and corners of the pixel display area of a glass substrate all differ from one another while the sensed pressure is uneasy to be calibrated. More importantly is that multi-touch sensing is unavailable in such type of touch panels, and such unavailability is a major technical issue.

Similarly, the electromagnetic touch panels must add the lead wires aligned in the first and second directions in the structure of the color filter substrate. The production processes must be also altered, and the production processes are more complicated and the production cost significantly increases.

### SUMMARY OF THE INVENTION

A first objective of the present invention is to provide a touchable sensing matrix unit on a co-constructed active array substrate.

To achieve the foregoing objective, the touchable sensing matrix on a co-constructed array having at least one set of conductive wires has multiple first sensing and transmitting wires and multiple second sensing and transmitting wires.

The first sensing and transmitting wires and the second sensing and transmitting wires are conductive and cyclic, and respectively correspond to the at least one set of conductive wires of the co-constructed active array substrate or an improved design using the at least one set of conductive wires of the co-constructed active array substrate. Each first sensing and transmitting wire and one of the second sensing and transmitting wires intersect to form an angle.

The insulation layer is mounted between the first sensing and transmitting wires and the second sensing and transmitting wires.

Preferably, the at least one set of conductive wires of the co-constructed active array substrate are a combination of data lines, scan lines, signal lines, read lines, bias lines, power lines, control lines, partial pixel circuits, common electrodes, partial auxiliary circuits, partial auxiliary pixels, auxiliary wires, compensation circuits, signal control lines for compensation circuit elements formed on the co-constructed active array substrate.

Preferably, the touchable sensing matrix unit further has at least one sensing and transmitting control unit or at least one sensing signal control unit. Each one of the at least one sensing and transmitting control unit or at least one sensing signal control unit is composed of at least one set of sensing signal control lines, two sets of sensing and transmitting common wires, multiple switches and multiple selection circuit elements to control signal or transmit, sense and detect signal of at least one first sensing and transmitting wire and at least one second sensing and transmitting wire.

Preferably, the touchable sensing matrix unit further has a multiplexing selection unit and a sensing and computing unit. The multiplexing selection unit has a first multiplexing selection unit and a second multiplexing selection unit. The first multiplexing selection unit is connected to and controls a part of the first sensing and transmitting wires. The second multiplexing selection unit is connected to and controls a part of the second sensing and transmitting wires. The sensing and computing unit is connected to the first multiplexing selection unit, the second multiplexing selection unit and each one of the at least one sensing and transmitting control unit or the at least one sensing and transmitting control unit.

Preferably, the first multiplexing selection unit and the second multiplexing selection unit select multiple conductive wires on the active array substrate to respectively form the first sensing and transmitting wires and the second sensing and transmitting wires to constitute multiple sensing and transmitting wires or sensing and transmitting wire branches of the touchable sensing matrix unit.

Preferably, the at least one sensing signal control unit controls the switches or the selection circuit elements through the at least one set of sensing signal control lines thereof to connect to at least one first sensing and transmitting wire and at least one second sensing and transmitting wire through the set of sensing and transmitting common wires to constitute multiple sensing and transmitting wires or sensing and transmitting wire branches of the touchable sensing matrix unit.

Preferably, the multiplexing selection unit selects one set of at least one first or second sensing and transmitting wire with the same line-to-line space or different line-to-line spaces and another one set of at least one first or second sensing and transmitting wire with the same line-to-line space or different line-to-line spaces, and the sensing and transmitting control unit controls the switches thereof to connect to or disconnect from the set of at least one first sensing and transmitting wire or the set of at least one second sensing and transmitting wire through the respective sets of sensing and transmitting common wires to constitute multiple sensing and transmitting loops or sensing loops of the touchable sensing matrix unit.

Preferably, the sensing signal control unit controls the switches thereof through the at least one set of signal sensing control lines to connect to one set of at least one first or second sensing and transmitting wire the same line-to-line space or different line-to-line spaces and another one set of at least one first or second sensing and transmitting wire with the same line-to-line space or different line-to-line spaces, further connect the set of at least one first or second sensing and transmitting wire and the set of at least one first or second sensing and transmitting wire to the respective sets of sensing and transmitting common wires and then respectively connect the set of at least one first or second sensing and transmitting wire to the set of at least one first or second sensing and transmitting wire through an internal loop of the multiplexing selection unit to constitute multiple sensing and transmitting loops or sensing loops of the touchable sensing matrix unit.

Preferably, the touchable sensing matrix is applicable to capacitive, resistive, pressure, pressure sensitive or pressure deformation sensing signals or wires for detecting, driving and exciting the sensing signals.

A second objective of the present invention is to provide a touchable sensing active array substrate having a co-constructed touchable sensing matrix.

To achieve the foregoing objective, the touchable sensing active array substrate has at least one set of conductive wires, a co-constructed touchable sensing matrix unit and at least one sensing and transmitting control unit or at least one sensing signal control unit.

The co-constructed touchable sensing matrix unit has multiple first sensing and transmitting wires and multiple second sensing and transmitting wires and an insulation layer.

The first sensing and transmitting wires and the second sensing and transmitting wires are conductive and cyclic, and respectively correspond to the at least one set of conductive wires of the co-constructed active array substrate or an improved design using the at least one set of conductive wires of the co-constructed active array substrate. Each first sensing and transmitting wire and one of the second sensing and transmitting wires intersect to form an angle.

The insulation layer is mounted between the first sensing and transmitting wires and the second sensing and transmitting wires.

The at least one sensing and transmitting control unit or at least one sensing signal control unit is electrically connected to the co-constructed touchable sensing matrix unit. Each one of the at least one sensing and transmitting control unit or at least one sensing signal control unit is composed of at least one set of sensing signal control lines, two sets of sensing and transmitting common wires, multiple switches and multiple selection circuit elements to control signal or transmit, sense and detect signal of at least one first sensing and transmitting wire and at least one second sensing and transmitting wire.

Preferably, a signal of the sensing and transmitting control unit or the sensing signal control unit is transmitted through a sensing and transmitting wire, a sensing and transmitting wire branch or a sensing and transmitting loop.

Preferably, the touchable sensing active array substrate further has a multiplexing selection unit and a sensing and computing unit. The multiplexing selection unit has a first multiplexing selection unit and a second multiplexing selection unit. The first multiplexing selection unit is connected to and controls a part of the first sensing and transmitting wires. The second multiplexing selection unit is connected to and controls a part of the second sensing and transmitting wires. The sensing and computing unit is connected to the first multiplexing selection unit, the second multiplexing selection unit and each one of the at least one sensing and transmitting control unit or the at least one sensing and transmitting control unit.

Preferably, the at least one sensing signal control unit controls the switches or the selection circuit elements through the at least one set of sensing signal control lines thereof to connect to at least one first sensing and transmitting wire and at least one second sensing and transmitting wire through the set of sensing and transmitting common wires to constitute multiple sensing and transmitting wires or sensing and transmitting wire branches of the touchable sensing matrix unit.

Preferably, the first sensing and transmitting wires and the second sensing and transmitting wires output or/and receive sensing signals having physical variations in terms of voltage, current or charge to the touchable sensing matrix, and the touchable sensing matrix analyzes a variance of the physical variation to determine parameters of touched point, height, touching activation intensity corresponding to the sensing signals having the physical variations.

Preferably, the multiplexing selection unit selects one set of at least one first or second sensing and transmitting wire and another one set of at least one first or second sensing and transmitting wire with the same line-to-line space or different line-to-line spaces, and the sensing and transmitting control unit control the switches thereof to connect to or disconnect from the set of at least one first or second sensing and transmitting wire and the set of at least one first or second sensing and transmitting wire through the respective sets of sensing and transmitting common wires to constitute multiple sensing and transmitting loops or sensing loops of the active array substrate.

Preferably, the sensing signal control unit controls the switches thereof through the at least one set of signal sensing control lines to connect to one set of at least one first or second sensing and transmitting wire and one set of at least one first or second sensing and transmitting wire with the same line-to-line space or different line-to-line spaces, further connects the set of at least one first or second sensing and transmitting wire and the set of at least one first or second sensing and transmitting wire to the respective sets of sensing and transmitting common wires and then respectively connect the set of at least one first or second sensing and transmitting wire to the set of at least one first or second sensing and transmitting wire through an internal loop of the multiplexing selection unit to constitute multiple sensing and transmitting loops or sensing loops of the active array substrate.

Preferably, the first sensing and transmitting wires and the second sensing and transmitting wires output or/and receive sensing signals having physical variations in terms of voltage, current or charge to the touchable sensing matrix, and the touchable sensing matrix analyzes a variance of the physical variation to determine parameters of touched point, height, touching activation intensity corresponding to the sensing signals having the physical variations.

Preferably, the touchable sensing active array substrate is applicable to capacitive, resistive, pressure, pressure sensitive or pressure deformation sensing signal or wires for detecting, driving and exciting the sensing signals.

Preferably, the touchable sensing active array substrate further has a display being one of a liquid crystal display device, an active matrix organic light-emitting diode, an electrophoretic display device and an electrowetting display device.

Speaking of absolute or relative magnitude, difference between peak values, average value, full-pixel location, signal intensity distribution of capacitive sensing signals, capacitance or charge is stored between the first and second sensing and transmitting wires and/or between fingers, or between insulation layers interlaced on the transmitting wires of the touchable sensing matrix unit, that is, each interlaced area can be treated as a sensing unit. Capacitive sensing also exists in each sensing unit and between fingers. Charge loses or is reduced from the sensing unit through the finger, and a charge distribution on the sensing unit is changed. The value, variation value or relative variation value of the charge can then be detected.

Speaking of absolute or relative magnitude, difference between peak values, average value, full-pixel location, signal intensity distribution of electromagnetic sensing signals, the first and second sensing and transmitting wires of the touchable sensing matrix are respectively connected to the first and second sensing and transmitting loops through respective switching sequences and sensing control lines. The first and second sensing and transmitting loops respectively serve as two sensing units to simultaneously transmit and receive electromagnetically excited signals and sequentially switch off two respective sensing and transmitting wires with a specific line-to-line space to form respective loops at different locations. The electromagnetic sensing signals at all sensed positions can be respectively sensed by a time sharing sequence or locations of multiple pixels or all pixels are simultaneously sensed in collaboration with IC sensing loops. Besides, the sensing and transmitting control unit or the sensing signal control unit can be mounted around sensors of the touchable sensing matrix, on the active array substrate or a peripheral circuit system thereof or inside a driving IC or a control IC of the circuit system.

Accordingly, elements with magnetic variation or magnetic flux variation of coils, elements having an LC loop oscillator or an electromagnetic pen can be used for inputting, and the pen tip is slippery and fine to facilitate writing.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a co-constructed active array substrate in accordance with the present invention;

FIG. 2 is a schematic view of a first embodiment of a flat panel display in accordance with the present invention;

FIG. 3 is a schematic view of a second embodiment of a flat panel display in accordance with the present invention;

FIG. 4 is a schematic view of a sensing matrix unit of the flat panel display in FIG. 3;

FIG. 5 is a schematic view of a third embodiment of a flat panel display in accordance with the present invention;

FIG. 6 is a schematic view of a sensing matrix unit of the flat panel display in FIG. 5;

FIG. 7 is a schematic view of a fourth embodiment of a flat panel display in accordance with the present invention;

FIG. 8 is a circuit diagram of a single pixel driving circuit unit of the flat panel display in FIG. 7;

FIG. 9 is a circuit diagram of an entire pixel driving circuit composed of the single pixel driving circuit unit in FIG. 8;

FIG. 10A is a circuit diagram of another single pixel driving circuit unit of the flat panel display in FIG. 7;

FIG. 10B is a time sequence diagram of the single pixel driving circuit unit in FIG. 10A.

FIG. 11 is a schematic view of a fifth embodiment of a flat panel display in accordance with the present invention;

FIG. 12 is a schematic view of a sixth embodiment of a flat panel display in accordance with the present invention;

FIG. 13 is a schematic view of a seventh embodiment of a flat panel display in accordance with the present invention;

FIG. 14 is a schematic view of a co-constructed active array substrate of the flat panel display in FIG. 13;

FIG. 15 is a schematic view of an eighth embodiment of a flat panel display in accordance with the present invention;

FIG. 16 is a circuit diagram of a driving circuit of the flat panel display in FIG. 15;

FIG. 17 is a schematic view of a self-capacitance sensing method in accordance with the present invention;

FIG. 18 is a schematic view of a mutual-capacitance sensing method in accordance with the present invention;

FIG. 19 is a schematic view of a co-constructed active array substrate containing multiplexing selection unit in accordance with the present invention;

FIG. 20 is a schematic view of another co-constructed active array substrate containing a multiplexing selection unit in accordance with the present invention;

FIG. 21 is a schematic view of a first co-constructed active array substrate containing a sensing and transmitting control unit in accordance with the present invention;

FIG. 22 is a schematic view of a second co-constructed active array substrate containing a sensing and transmitting control unit in accordance with the present invention;

FIG. 23 is a schematic view of an electromagnetic sensing method in accordance with the present invention;

FIG. 24 is a schematic view of a third co-constructed active array substrate containing a sensing and transmitting control unit in accordance with the present invention;

FIG. 25 is an exploded schematic view of a conventional touch panel;

FIG. 26 is a cross-sectional view of a conventional touch panel;

FIG. 27 is a top view of a color filter substrate and a TFT array substrate in FIG. 26; and

FIG. 28 is a cross-sectional view of another conventional touch panel.

### DETAILED DESCRIPTION OF THE INVENTION

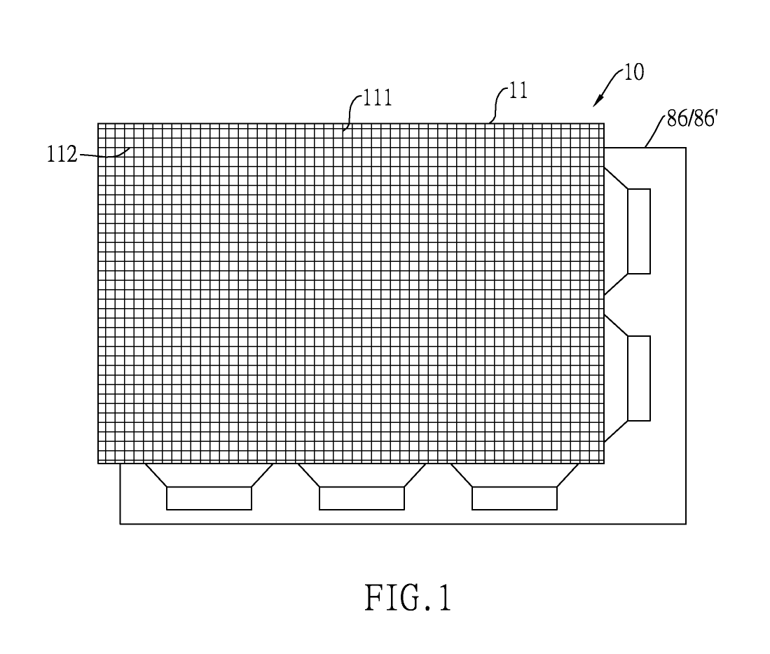

With reference to FIG. 1, a co-constructed active array substrate 10 in accordance with the present invention has a touchable sensing matrix unit 11 formed thereon. The touchable sensing matrix unit 11 has multiple first sensing and transmitting wires 111, multiple second sensing and transmitting wires 112 and an insulation layer. The first and second sensing and transmitting wires 111, 112 are conductive and cyclic, and intersect to form an angle, such as 30°, 45°, 60°, 90° or 120°. The insulation layer is formed between the first and second sensing and transmitting wires 111, 112. The touchable sensing matrix unit 11 has at least one set of wires of the co-constructed active array substrate 10. In the present embodiment, the first and second sensing and transmitting wires 111, 112 of the touchable sensing matrix unit 11 have two respective sets of wires of the co-constructed active array substrate 10.

Alternatively, the co-constructed active array substrate 10 has a sensing matrix formed thereon and further has multiple first sensing and transmitting wires 111, multiple second sensing and transmitting wires 112 and an insulation layer. The first and second sensing and transmitting wires 111, 112 are conductive and cyclic, and intersect to form an angle, such as 30°, 45°, 60°, 90° or 120°, with the insulation formed therebetween to sense a physical variation signal at a touched point. The sensing matrix 11 has at least one set of wires of the co-constructed active array substrate 10. The co-constructed active array substrate 10 further has a sensing and transmitting control unit 86 or a sensing signal control unit 86′, serving to output a sensing request for physical variation signal to the touchable sensing matrix unit 11, receive a physical variation signal, analyze a variance of the physical variation signal, determine parameters, such as touched point, height, touching activation intensity and the like, corresponding to the physical variation signal. The sensing and transmitting control unit 86 or at least one sensing signal control unit 86′ is partially or wholly integrated on a substrate of the touchable sensing active array substrate using amorphous silicon, low-temperature poly-silicon and high-temperature poly-silicon manufacturing workmanship and technique and a system integration technique of glass substrate.

The signal of the sensing and transmitting control unit 86 or the sensing signal control unit 86′ may be transmitted through a sensing and transmitting wire, a sensing and transmitting wire branch or a sensing and transmitting loop. The received physical variation signal may be magnetic flux of electromagnetic induction, electromagnetic induction, touch sensing loop signals in the form of voltage, current or frequency, charges induced by capacitor, capacitive induction, sensing signals in the form of voltage or current, and resistive, optical or pressure sensing signals in the form of voltage, current, waveform or the like, and may be the value, absolute or relative magnitude, difference between peak values, average value, full-pixel location, signal intensity distribution and the like to determine parameters such as touched point, height, touching activation intensity and the like. Elements being magnetic or having magnetic flux variation of coil or LC loop oscillator or electromagnetic pens are used for inputting. The tips of the elements or electromagnetic pens should be fine and slippery to facilitate writing.

The co-constructed active array substrate may be a display, a flat panel display, an active matrix organic light-emitting diode (AMOLED), an electrophoretic display, liquid crystal on silicon (LCoS) and so forth.

The co-constructed active array substrate can be applied to various displays in collaboration with different driving circuits or signal control loops, and the touch control concepts are described as follows.

Case 1: Active Array TFT LCD Display (I)

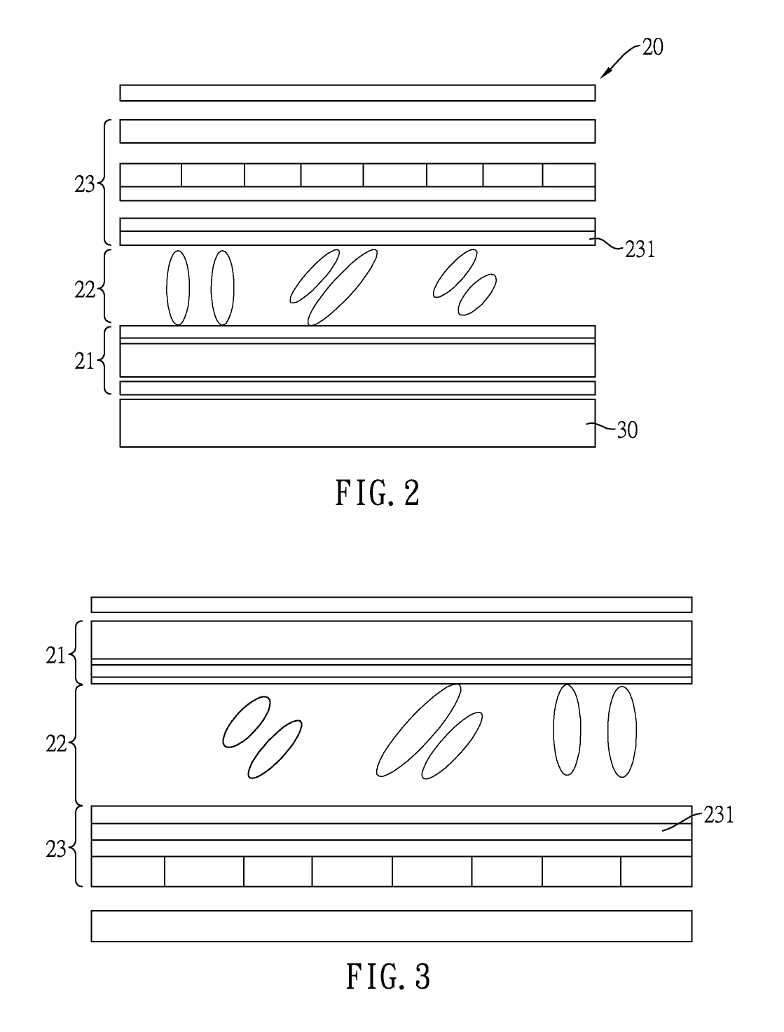

With reference to FIG. 2, an active array TFT LCD display or flat panel display may be one of transmissive, reflective and transflective TFT LCD display or low-temperature poly-Si (LTPS) TFT displays, or an LcoS formed by micro-pixel array on semiconductor chips. The active array TFT LCD display at least has an upper substrate 23, a lower active array substrate 21 and a liquid crystal layer 22. The upper substrate 23 may be a color filter substrate and has a common electrode 231 formed thereon. The lower active array substrate 21 is a co-constructed active array substrate. The liquid crystal layer 22 is mounted between the upper substrate 23 and the lower active array substrate 21. In the case of a transmissive display, the active array TFT LCD display further has a backlight module 30 mounted on a bottom thereof. If considering that electrode signals of the common electrode 231 possibly mask capacitive sensing signals, the present case is preferably applied to electromagnetic sensing control instead of capacitive sensing control. Given a specific circuit analysis processing, if the masking issue can be resolved, dual-mode touchable sensing display can still be implemented to have multi-touch functions for stylus and fingers.

Case 2: Active Array TFT LCD Display (II)

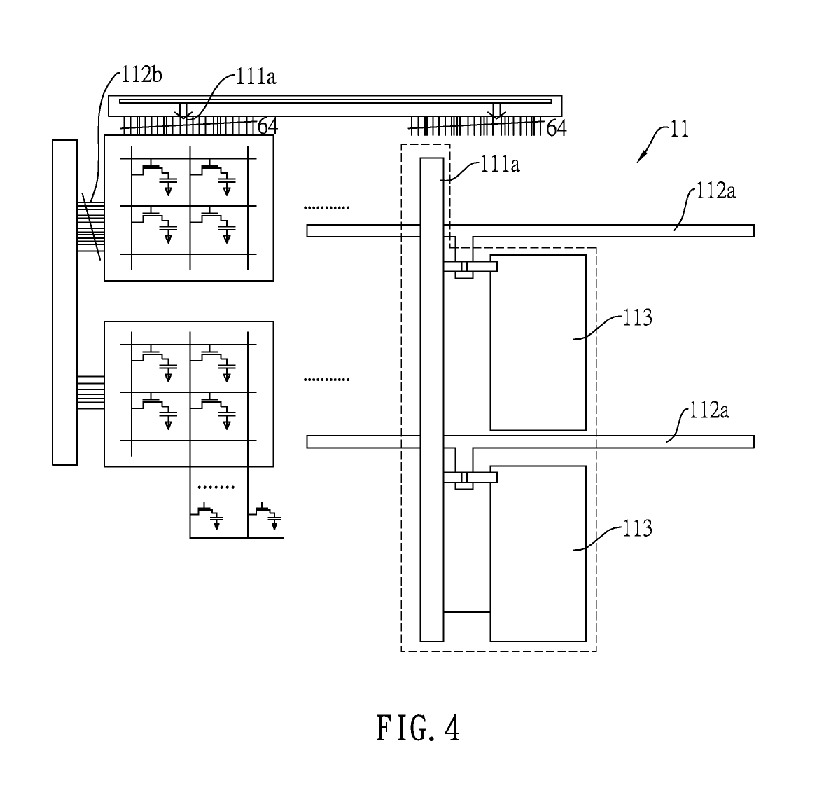

In the present case, with reference to FIG. 3, the active array TFT LCD display or flat panel display may be a transmissive TFT LCD display or an LTPS TFT LCD display, and at least has an upper active array substrate 21, a lower color filter substrate 23 and a liquid crystal layer 22. The upper active array substrate 21 is a co-constructed active array substrate. The liquid crystal layer 22 is mounted between the upper active array substrate 21 and the lower color filter substrate 23. The first and second sensing and transmitting wires of the touchable sensing matrix unit in accordance with the present invention are data lines and scan lines formed on an active array substrate of the upper active array substrate 21. According to the design of the co-constructed active array substrate, the first or second sensing and transmitting circuit of the touchable sensing matrix unit may be implemented and co-constructed by signal lines, read lines, bias lines, control lines, partial pixel circuits, partial auxiliary circuits, auxiliary lead wires or improved design using the foregoing lines. With reference to FIG. 4, scan lines 112a and data lines 111a can jointly serve as the first or second sensing and transmitting circuits. The data lines 111a and pixel electrodes 113 may be mutually connected by electronic signal control to constitute a larger touchable sensing area and electrodes to facilitate enhanced signal sensing. As the color filter substrate 23 of the present case is located below, capacitive sensing signals are uneasy to be masked by the common electrode 231 on the color filter substrate 23.

Moreover, as the data lines 111a, the scan lines 112a and the common electrode have high line density, the sensing matrix 11 of the present invention can consider a touch range by a single finger including multiple data lines 111a, scan lines 112a and common electrodes simultaneously. In the case of a flat panel display having a screen resolution 1024×768, with further reference to FIG. 4, the data lines 111a can have 64 lines per unit to correspond to 16 second sensing and transmitting wires and the scan lines 112a can have 64 lines per unit to correspond to 12 second sensing and transmitting wires. In brief, a display having a resolution 1024×768 can correspond to a (N×M) 16×12 touchable sensing matrix unit.

Case 3: Active Array TFT LCD Display of Flat Panel Display Similar to that in Case 1

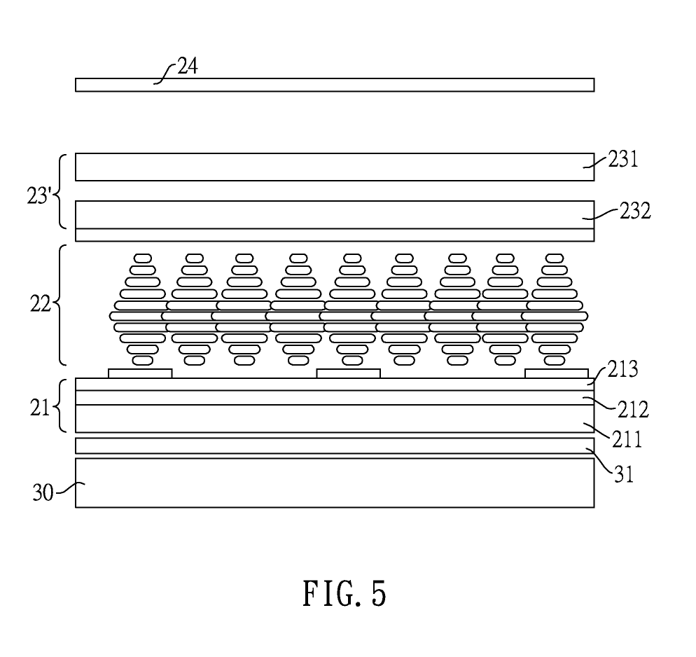

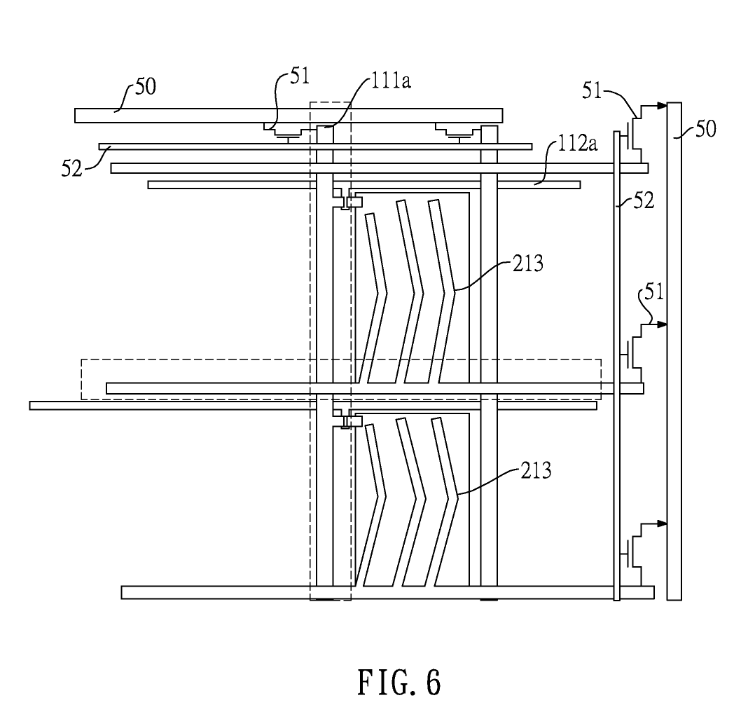

With reference to FIG. 5, a fringe field switching wide viewing angle TFT LCD display at least has a lower active array substrate 21, an upper substrate 23′, a polarizer 24 and a liquid crystal molecule layer 22. The lower active array substrate 21 has a first substrate 211, a pixel layer 212 and a common electrode layer 213. The pixel layer 212 and the common electrode layer 213 are sequentially formed on one side of the first substrate 211 and the structure thereof has a fringe field design as shown by the common electrode layers 213 in FIG. 6, and each two common electrode layers 213 are separated by an insulation layer. The active array TFT LCD display in the present case may further have a color filter layer 232 mounted on the substrate 231 of the upper substrate 23′ while containing no common electrodes. The first and second sensing and transmitting wires of the touchable sensing matrix unit may be co-constructed by the data lines, the common electrode lines, the scan lines, or an improved design using the foregoing lines.

The display of the present case may further have a polarizer 31 and a backlight source 30. The polarizer 31 is mounted under the first substrate 211 of the lower active array substrate 21. The backlight source 30 is mounted under the polarizer 31.

The fringe field switching TFT array further has a flat layer and an insulation layer. The flat layer covers a top of the pixel layer 212 of the lower active array substrate 21 so as to connect the drains of the thin film transistors to the pixel layer 212 above the flat layer through contact holes. The pixel layer 212 is formed by transparent electrodes, such as ITO or IZO electrodes. The insulation layer is formed on a top of the pixel layer 212. The common electrode layer on a top of the insulation layer takes the form of a comb, a grid or a curved comb and is also formed by transparent electrodes, such as ITO or IZO electrodes.

The first and second sensing and transmitting wires of the touchable sensing matrix unit of the present invention may be the data lines 111a and scan lines 112a, the data lines 111a and the common electrode layers 213, the scan lines 112a and the common electrode layers 213 or an improved design using the foregoing lines on the upper active array substrate 21. Such display, if using electromagnetic sensing, may have a sensing signal line 50 and a switch 51 corresponding to the sensing signal line 50 and a sensing signal control line 52 for switching the switch 51 to connect to the data lines and the common electrode layers 213.

Case 4: AMOLED Display

The dual-mode touch control elements and the elements of the co-constructed active array substrate can be also applied to an organic LED display.

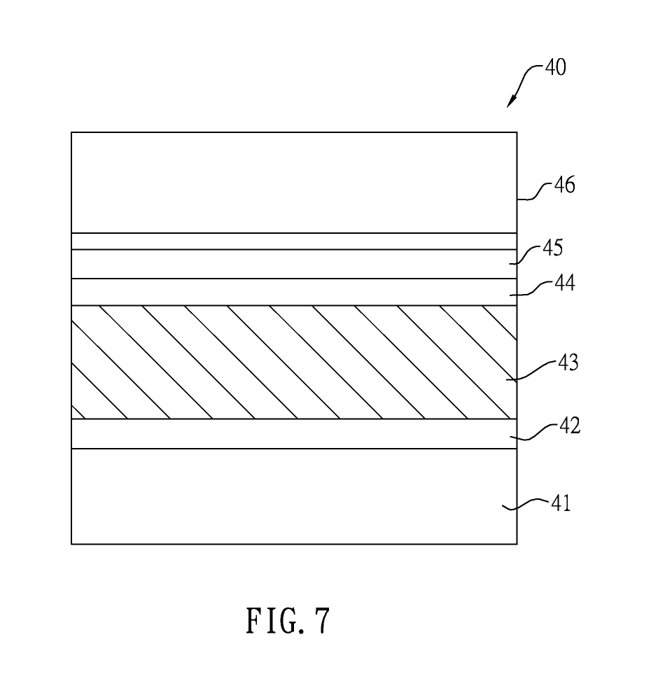

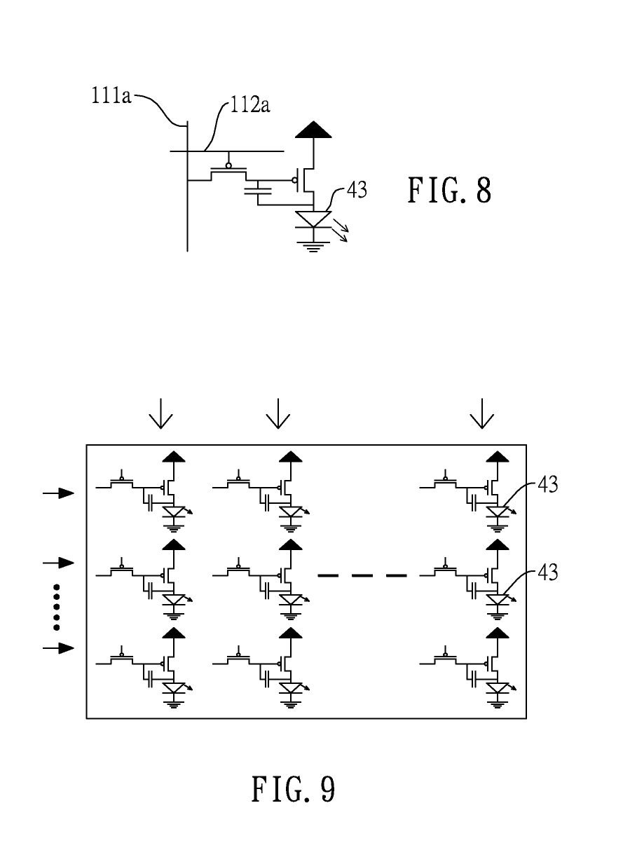

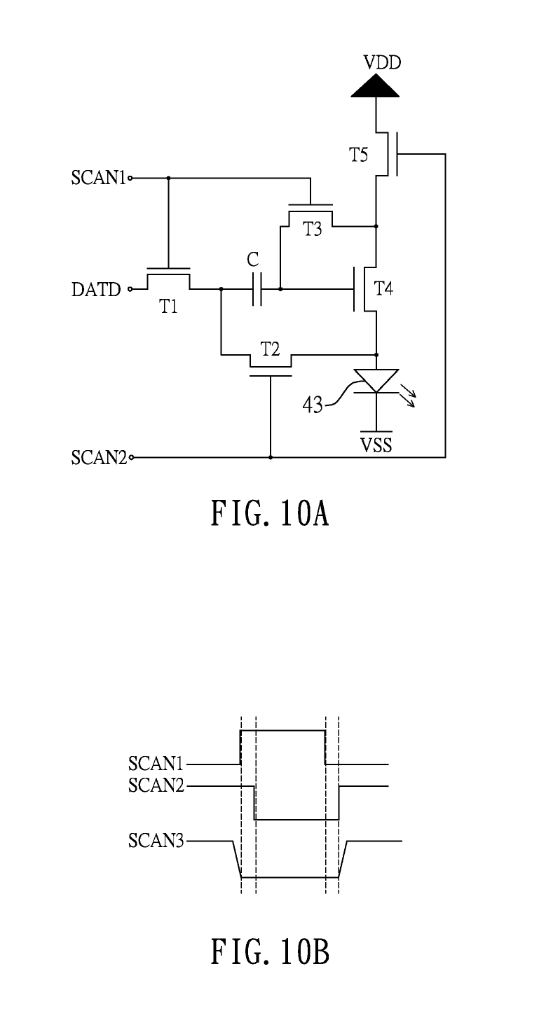

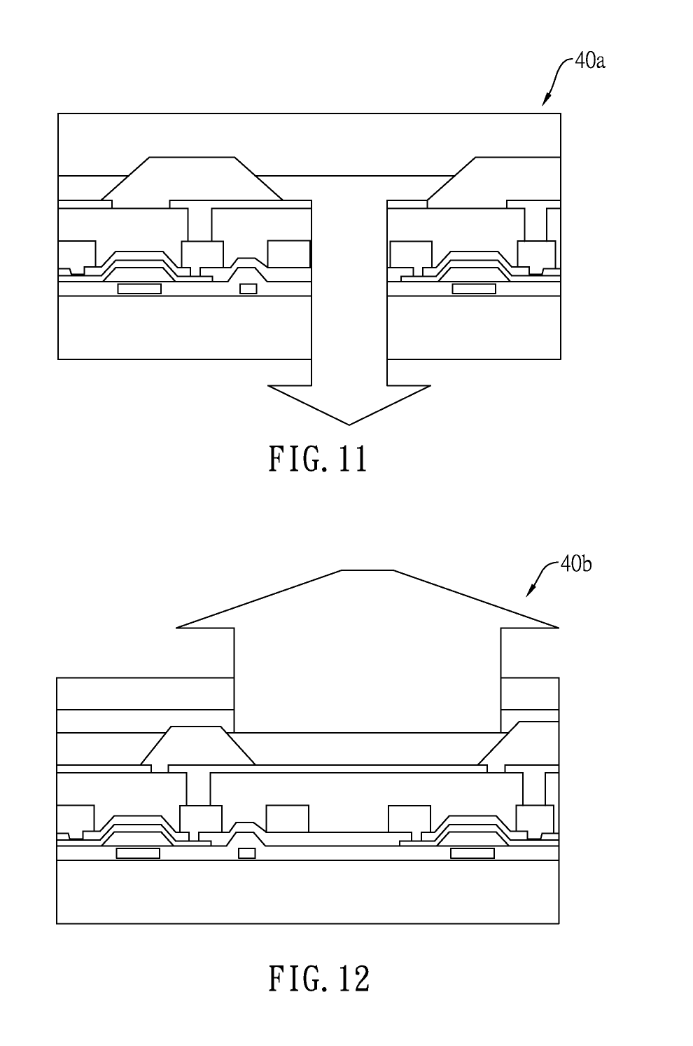

With reference to FIG. 7, a dual-mode touchable sensing matrix unit is formed within an organic LED display 40. The organic LED display 40 at least has a first substrate 41, a first electrode 42, an organic light-emitting unit 43, a second electrode 44, a protection layer 45 and a second substrate 46. The first electrode 42 may have a co-constructed active array substrate, a LTPS TFT array or the like and may further have auxiliary circuits, elements and the like. With reference to FIGS. 8 and 9, a circuit for driving the organic light-emitting unit 43 is shown. With reference to FIGS. 10 and 11, another circuit for driving the organic light-emitting unit 43 is shown and has five TFT switches T1˜T5, a capacitor C and two control lines SCAN1 and SCAN2. In consideration of the material property, material reliability and uniformity of production process for OLED, the AMOLED display requires many auxiliary lines and TFT switches except the pixel electrode. Hence, the driving circuit using five TFT switches T1˜T5 and a capacitor C has a compensation effect on stabilizing or compensating voltage, current or Vₜₕ of the driving circuit. The current of the OLED is I_{oled}=K(V_{oled0}−V_{data})² is durable against the material aging issue over a long period of time and is not affected by the variation of Vₜₕ of the circuit. The co-constructed touchable sensing matrix unit may be composed of multiple mutually intersecting scan lines and data lines of the active array substrate, or may be further collaborated with signal lines, read lines, bias lines, power lines, control lines, partial pixel circuits, common electrodes, partial compensation circuits, partial auxiliary pixels, auxiliary lead wires, compensation circuits, or signal control lines, auxiliary lines or circuits for compensation circuit elements, or improved designs using the foregoing lines.

With further reference to FIG. 11, a bottom-emitting OLED flat panel display 40a using capacitive sensing control or electromagnetic sensing control may be co-constructed with a TFT array of a lower substrate. Signals of the bottom-emitting OLED flat panel display 40a is not easily masked by the anode or cathode. With reference to FIG. 12, a top-emitting OLED flat panel display 40b preferably using electromagnetic sensing is shown. The top-emitting OLED flat panel display can use capacitive sensing and electromagnetic sensing and may be co-constructed with the TFT array of the lower substrate while the capacitive sensing signals are easily masked by the transparent cathode.

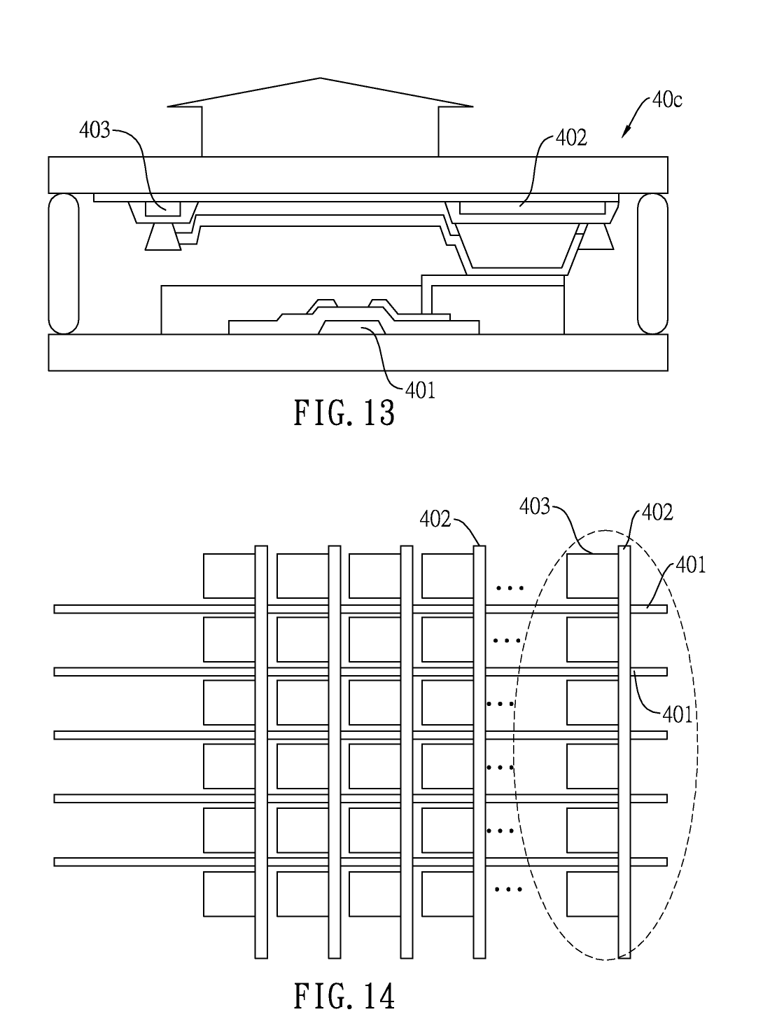

Preferably, with reference to FIGS. 13 and 14, a dual-mode touchable top-emitted AMOLED display 40c has wires thereof formed and distributed on an upper substrate and a lower substrate. The first sensing and transmitting wires of the AMOLED display may be TFT gate bus lines, and the second sensing and transmitting wires may be auxiliary electrodes on the upper substrate. Anodes of pixel areas are isolated and not directly connected with each other but connected through the respective auxiliary electrodes. Cathodes of pixel areas are also isolated and not directly connected with each other but connected through the respective drains of the pixel arrays. Hence, the horizontal sensing and transmitting wires have better sensing result under the circumstance of capacitive sensing signals not masked by the anodes and cathodes.

Case 5: Active Array Electrophoretic Display

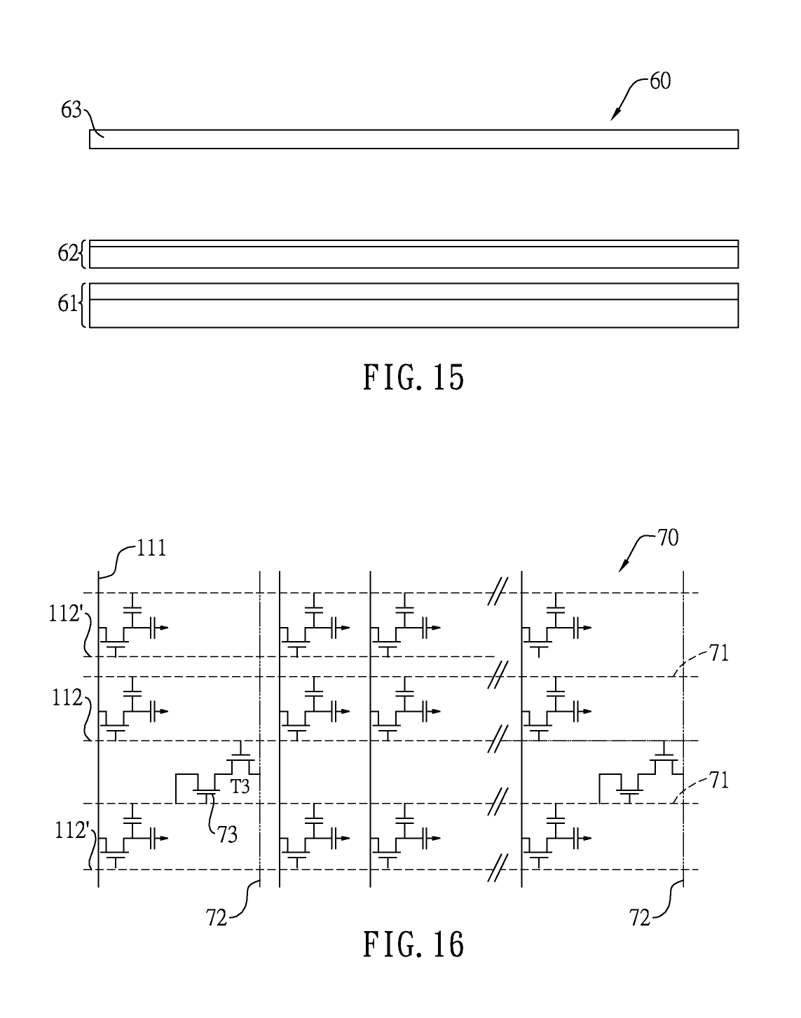

With reference to FIG. 15, the active array electrophoretic display or flat panel display 60 at least has a TFT array substrate 61, an electrophoretic layer 62 formed on the TFT array substrate 61, and a protection substrate 63 having a common electrode layer formed thereon. With reference to FIG. 16, the first and second sensing and transmitting wires of the touchable sensing matrix unit of the present invention may be data lines and scan lines on the upper active array substrate.

The protection substrate 63 may be a flexible film, plastic material, PET material or a glass substrate, and may include a color filter, a common electrode layer and an upper substrate stacked on the color filter and the common electrode layer.

Case 6: Multi-Mode Sensing Touchable Display

The present case pertains to a pixel array design of a photosensing touchable LCD display, and may be a multi-mode co-constructed active array substrate having optical sensing, capacitive sensing and electromagnetic sensing as a whole, or a multi-mode touchable LCD display.

With reference to FIG. 16, an optical touchable LCD display 70 has a first and second pixel units in terms of its pixel array design. The first and second pixel units have 3 TFT switches T1, T2 and T3 and an optical sensing element 73. Scan lines 112, data lines 111 are available in the regular design. Auxiliary scan lines 112′, bias lines 71 and read lines 72 are additionally mounted.

The first and second sensing and transmitting wires of the touchable sensing matrix unit of the present invention are transversely implemented by the scan lines 112, the auxiliary scan lines 112′ and the bias lines 71, and longitudinally implemented by data lines 111 and/or read lines 72. When the bias lines 71, the read lines 72 and the scan lines 112 are used, the capacitive sensing function and the electromagnetic sensing function can be implemented.

Based on the design of the present invention, the photosensing pixel design may be adapted to an LCD display having optical sensing and electromagnetic sensing functions, or a multi-mode co-constructed touchable LCD display having optical sensing, capacitive sensing and electromagnetic sensing.

As a result, the co-constructed touchable sensing matrix unit and the co-constructed active array substrate of the present invention may be applied to various active array displays, flat panel displays, AMOLED display, electrophoretic display and the like.

Sensing methods of various active array flat panel displays are further described as follows.

1. Capacitive Sensing Method

With regard to absolute or relative magnitude, peak value difference, average value, full-pixel positions and signal intensity distribution for capacitive sensing, capacitance or charge is stored between the first and second sensing and transmitting wires and/or between fingers, or between insulation layers interlaced on the transmitting wires of the touchable sensing matrix unit, that is, each interlaced area can be treated as a sensing unit. Capacitive sensing also exists in each sensing unit and between fingers. Charge loses or is reduced from the sensing unit through the finger, and a charge distribution on the sensing unit is changed. The value, variation value or relative variation value of the charge can then be detected. Given the detection, positions, distances, touched heights and touched points having sensing variation can be determined by calculating the values of charge, capacitance, voltage and current signals.

(A) Capacitive Sensing Detection Method One

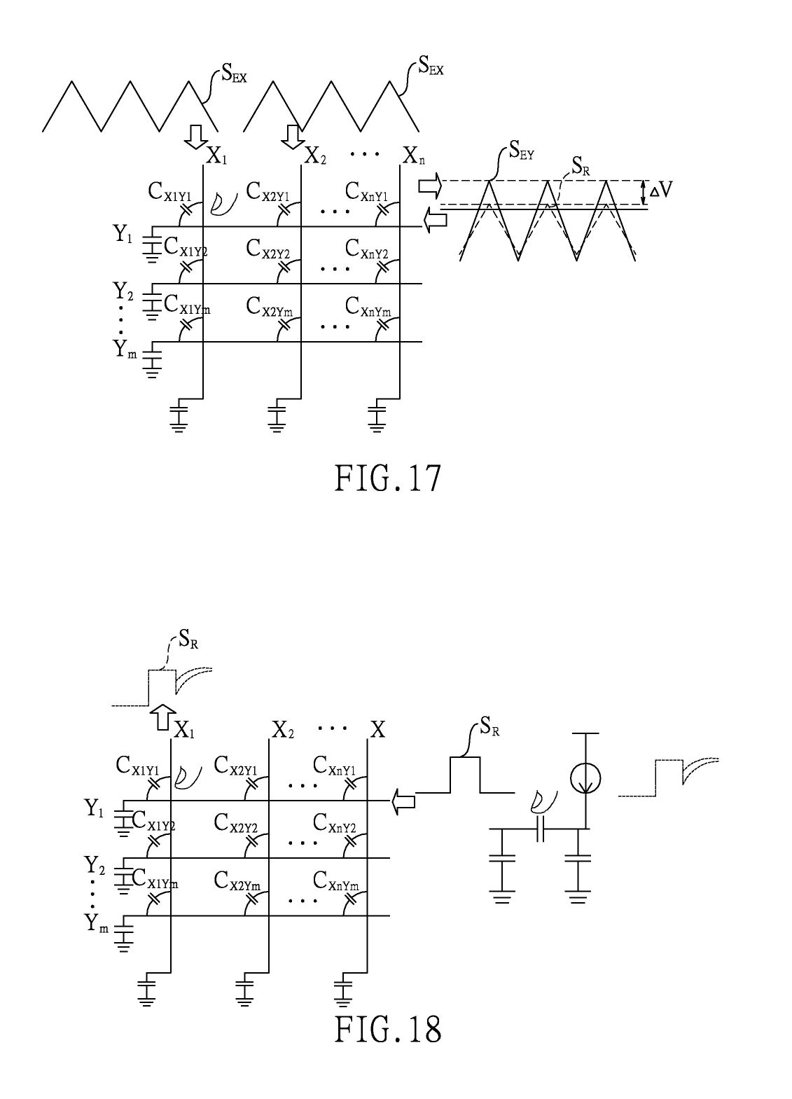

With reference to FIG. 17, one of the first electrodes Xk is excited to drive an excited signal S_{EX}, and the Xk receives and detects a voltage variation value of the waveform S_{R} (normally triangular wave AC voltage signals) to determine if the capacitance distribution and a waveform thereof has been changed by a finger touch. Similarly, one of the second electrodes Yk is excited to drive another excited signal S_{EY} so as to determine the change on waveform done by the finger touch.

(B) Capacitive Sensing Detection Method Two

With reference to FIG. 18, when the Y1 column is given an excitation value or excitation signal S_{E}, a square wave signal (pulse/step function), at the X1 to Xn, sequentially detects respective signals. Due to capacitance of a finger and the resulting sensing at C_{X1Y1}, the detected sensing waveform S_{R} is therefore distorted. Hence, a capacitance value or a capacitance variation value (ΔC) can be estimated by a RC delay time and degree of waveform distortion or a value judgment ΔQ_{x1,y1}αΔC_{x1,y1}. It holds true for the following within the circuit in FIG. 18.

Electrodes in the Xⱼ row are longitudinally connected with each other.

Electrodes in the Yₖ column are transversely connected with each other.

Capacitance is generated between two separate insulation layers on each intersection.

Capacitance sensing effect occurs between electrodes in each row and each column.

C_{X1, Y1} is a capacitance value mutually sensed by the electrodes in X1 row and Y1 column.

C_{X3, Y2} is a capacitance value mutually sensed by the electrodes in X3 row and Y2 column.

C_{X1, g} is a capacitance value sensed by the electrodes in X1 row and the ground.

The equivalent capacitances in X1 column and X2 column are:

C_{X1}=C_{X1, g}+C_{X1, Y1}+C_{X1, Y2}+C_{X1, Y3}+ . . .

C_{X2}=C_{X2, g}+C_{X2, Y1}+C_{X2, Y2}+C_{X2, Y3}+ . . .

Similarly, the equivalent capacitances in Y1 column and Y2 column are:

C_{Y1}=C_{Y1, g}+C_{X1, Y1}+C_{X2, Y1}+C_{X3, Y1}+ . . .

C_{Y2}=C_{Y2, g}+C_{X1, Y2}+C_{X2, Y2}+C_{X3, Y2}+ . . .

Although the touchable sensing matrix unit of the present invention is narrow and elongated, the rows and columns of electrodes are densely arranged therein and there are insulation layers on the intersection of the rows and columns. Therefore, one electrode in each row and one electrode in a corresponding column also have a capacitive sensing effect.

The touchable sensing matrix unit in cases 1 to 6 further has a sensing detection unit. The sensing detection unit for implementing the foregoing capacitive sensing detection method one and two is described as follows.

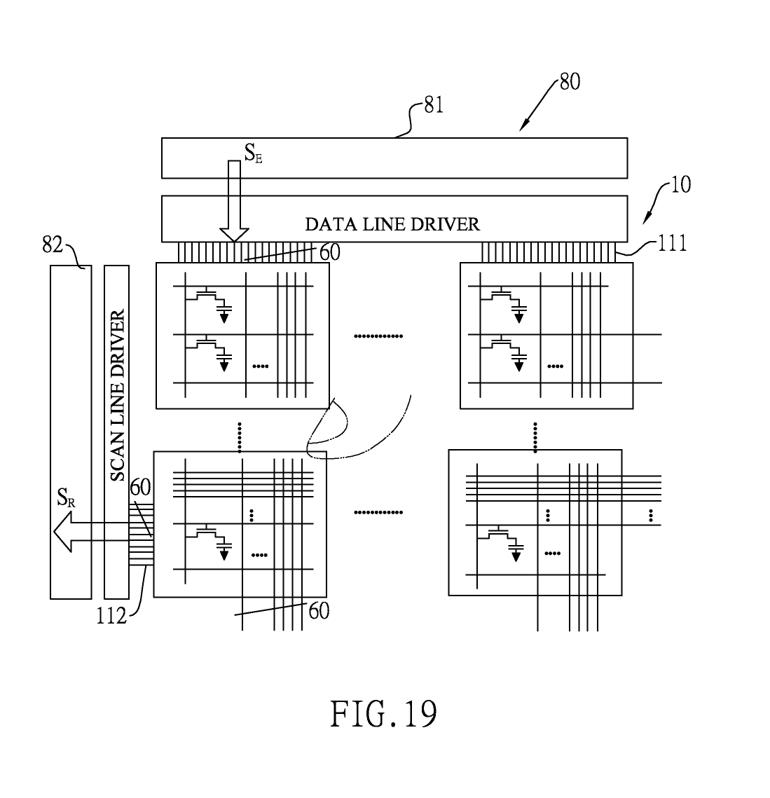

(a) With reference to FIG. 19, a multiplexing selection unit 80 of the active array substrate 10 has a first multiplexing selection unit 81 and a second multiplexing selection unit 82.

The first multiplexing selection unit 81 corresponds to multiple first sensing and transmitting wires 111 and has a first selection unit, such as a multiplexer, and a first sensing and computing unit. For example, the first selection unit of the first multiplexing selection unit 81 can simultaneously select 60 first sensing and transmitting wires 111. The first sensing and computing unit can simultaneously send an excitation signal to the 60 first sensing and transmitting wires.

The second multiplexing selection unit 82 corresponds to multiple second sensing and transmitting wires 112 and has a second selection unit, such as a multiplexer, and a second sensing and computing unit. For example, the second selection unit of the second multiplexing selection unit 82 can simultaneously select 60 second sensing and transmitting wires 112. The second sensing and computing unit can simultaneously receive sensing signals from the 60 second sensing and transmitting wires and calculate coordinates of touched positions depending on if the received sensing signals vary.

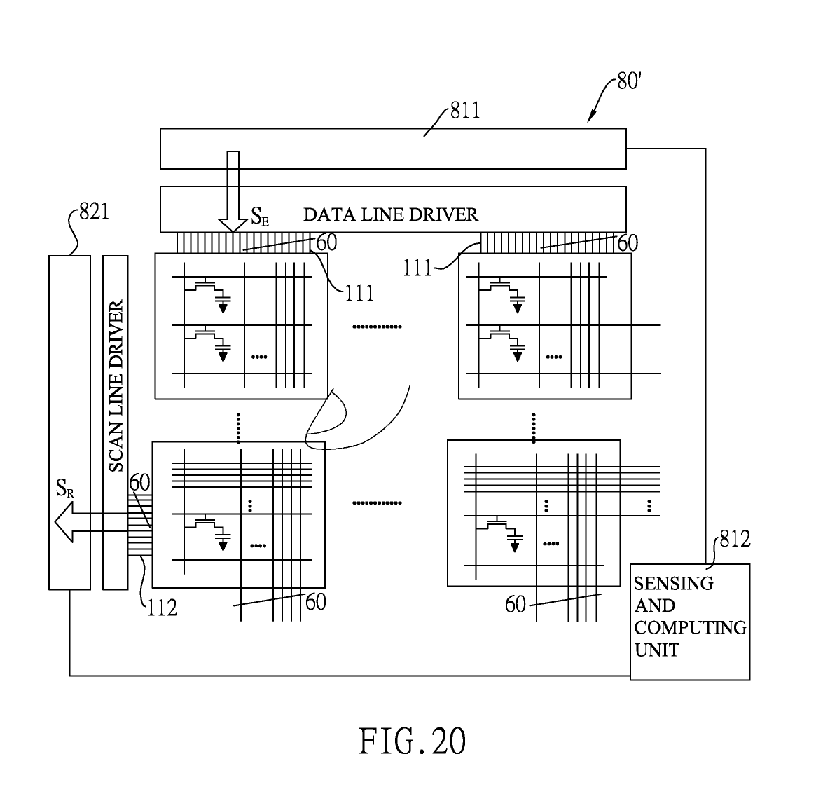

(b) With reference to FIG. 20, a multiplexing selection unit 80′ of the active array substrate 10 has a first multiplexing selection unit 811, a second multiplexing selection unit 821 and a sensing and computing unit 812.

The first multiplexing selection unit 811 corresponds to multiple first sensing and transmitting wires 111. For example, the first multiplexing selection unit 811 can simultaneously select 60 first sensing and transmitting wires 111.

The second multiplexing selection unit 821 corresponds to multiple second sensing and transmitting wires 112. For example, the second multiplexing selection unit 821 can simultaneously select 60 second sensing and transmitting wires 112.

The sensing and computing unit 812 is connected to and controls the first multiplexing selection unit 811 and the second multiplexing selection unit 821. The sensing and computing unit 812 first sends excitation signal S_{E} to the 60 first sensing and transmitting wires 111 selected by the first multiplexing selection unit 811, then receives sensing signals S_{R} returned from the 60 second sensing and transmitting wires selected by the second multiplexing selection unit 821, determines if the received sensing signal S_{R} vary, and if positive, detects the signals associated with the sensed charges, capacitance, voltage or current, and calculates values of the signals to determine positions, distances, touched heights and touching intensity generating sensing variations.

2. Electromagnetic Sensing Method

As the electromagnetic sensing method requests that the first sensing and transmitting wires 111 and the second sensing and transmitting wires 112 be time-sharing and respectively constitute closed loops to sense variation of electromagnetic field, one common end of the first sensing and transmitting wires 111 of the touchable sensing matrix unit on the active array substrate 10 of each of the cases 1 to 3 is connected to a first sensing and transmitting common wire 115 through a first switch SW1 (thin-film transistor), and one common end of the second sensing and transmitting wires 112 is connected to a second sensing and transmitting common wire 116 through a second switch SW2. To implement such circuit, the active array substrate can have the following options.

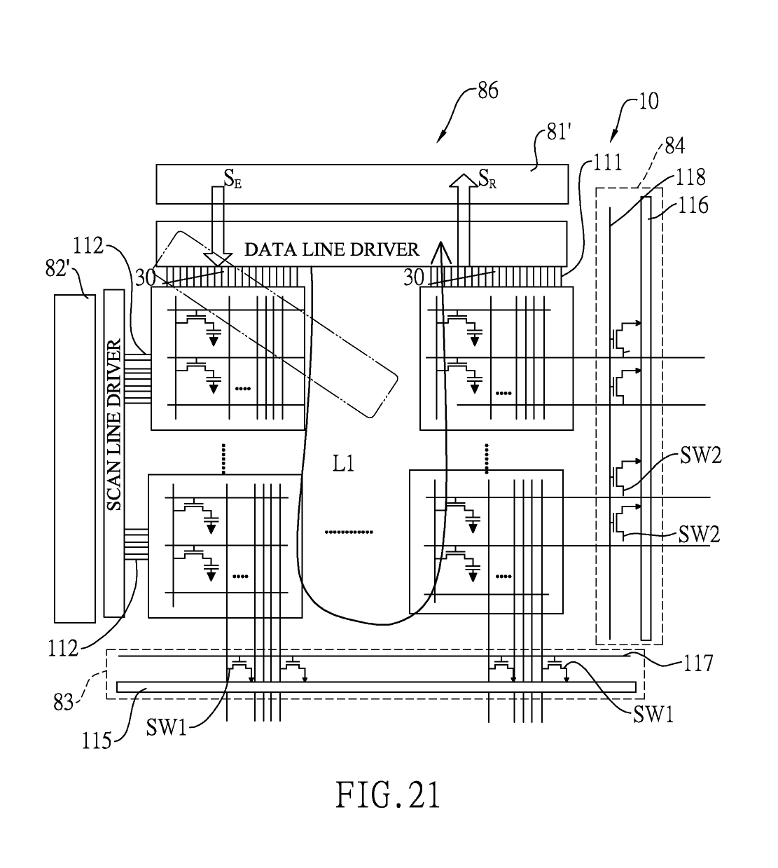

Option 1: With reference to FIG. 21, the active array substrate further has a first sensing and transmitting control unit 83, a second sensing and transmitting control unit 84, a first multiplexing selection unit 81′ and a second multiplexing selection unit 82′.

The first sensing and transmitting control unit 83 corresponds to multiple first sensing and transmitting wires 111, and has a first sensing and transmitting common wire 115, multiple first switches SW1 and a first sensing signal control wire 117. The first sensing and transmitting common wire 115 is connected to the first sensing and transmitting wires 111. Each first switch SW1 is connected to one of the first sensing and transmitting wires 111 and the first sensing and transmitting common wire 115. The first sensing signal control wire 117 is connected to the control ends of the first switches SW1 and controls to switch all the first switches SW1.

The second sensing and transmitting control unit 84 corresponds to multiple second sensing and transmitting wires 112 and has a second sensing and transmitting common wire 116, multiple second switches SW2 and a second sensing signal control wire 118. The second sensing and transmitting common wire 116 is connected to the second sensing and transmitting wires 112. Each second switch SW2 is connected to one of the second sensing and transmitting wires 112 and the second sensing and transmitting common wire 116. The second sensing signal control wire 118 is connected to a control end of the second switch SW2 and controls to switch all the second switches SW2.

The first multiplexing and selection unit 81′ corresponds to multiple first sensing and transmitting wires 111 and the first sensing signal control wire 117 of the first sensing and transmitting control unit 83. In the present option, the first multiplexing and selection unit 81′ has a first selection unit, such as a multiplexer, and a first sensing and computing unit. For example, the first selection unit of the first multiplexing and selection unit 81′ can simultaneously select two separate and relevant sets of 30 first sensing and transmitting wires 111 and simultaneously control the first sensing signal control wire 117 to switch on the first switch SW1 and connect the first sensing and transmitting wires 111 with the first sensing and transmitting common wire 115 to constitute a first sensing and transmitting loop L1. The first sensing and computing unit 81′ then sends an excitation signal S_{E} to one of the two sets of first sensing and transmitting wires 111, and receives sensing signals from the other set of 30 first sensing and transmitting wires 111. The two sets of first sensing and transmitting wires 111 have a gap therebetween and the gap corresponds to a sensing area, such as 100 wire pitches.

The second multiplexing and selection unit 82′ corresponds to multiple second sensing and transmitting wires 112 and the second sensing signal control wire 118 of the second sensing and transmitting control unit 84. In the present option, the second multiplexing and selection unit 82′ has a second selection unit, such as a multiplexer, and a second sensing and computing unit. For example, the second selection unit of the second multiplexing and selection unit 82′ can simultaneously select two separate and relevant sets of 30 second sensing and transmitting wires 112 and simultaneously control the second sensing signal control wire 118 to switch on the second switch SW2 and connect the second sensing and transmitting wires 112 with the second sensing and transmitting common wire 116 to constitute a second sensing and transmitting loop. The second sensing and computing unit 82′ then sends an excitation signal S_{E} to one of the two sets of first sensing and transmitting wires 111, and receives sensing signals from the other set of 30 second sensing and transmitting wires 112. The two sets of first sensing and transmitting wires 111 have a gap therebetween and the gap corresponds to a sensing area, such as 100 wire pitches.

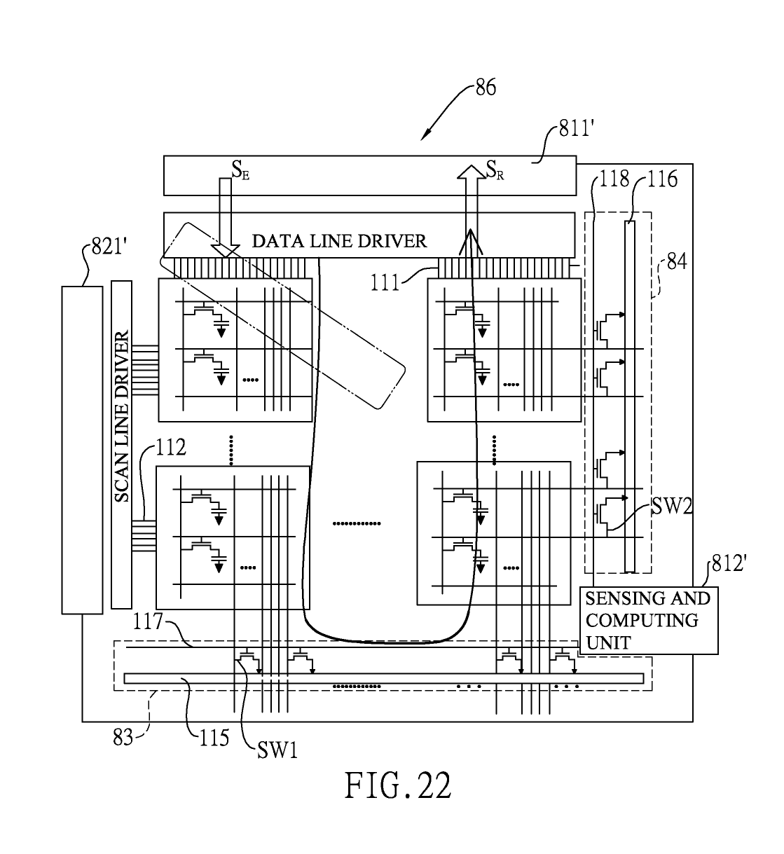

Option 2: With reference to FIG. 22, a sensing and transmitting control unit 86 of the active array substrate further has a first sensing and transmitting control unit 83, a second sensing and transmitting control unit 84, a first multiplexing selection unit 811′, a second multiplexing selection unit 821′ and a sensing and computing unit 812′.

The first sensing and transmitting control unit 83 corresponds to multiple first sensing and transmitting wires 111, and has a first sensing and transmitting common wire 115, multiple first switches SW1 and a first sensing signal control wire 117. The first sensing and transmitting common wire 115 is connected to the first sensing and transmitting wires 111. Each first switch SW1 is connected to one of the first sensing and transmitting wires 111 and the first sensing and transmitting common wire 115. The first sensing signal control wire 117 is connected to a control end of the first switch SW1 and controls to switch all the first switches SW1.

The second sensing and transmitting control unit 84 corresponds to multiple second sensing and transmitting wires 112 and has a second sensing and transmitting common wire 116, multiple second switches SW2 and a second sensing signal control wire 118. The second sensing and transmitting common wire 116 is connected to the second sensing and transmitting wires 112. Each second switch SW2 is connected to one of the second sensing and transmitting wires 112 and the second sensing and transmitting common wire 116. The second sensing signal control wire 118 is connected to a control end of the second switch SW2 and controls to switch all the second switches SW2.

The first multiplexing selection unit 811′ is connected to the first sensing and transmitting wires 111. For example, two sets of 30 first sensing and transmitting wires 111 can be simultaneously selected, each set of first sensing and transmitting wires 111 has a fixed line-to-line space and the two sets of first sensing and transmitting wires 111 have a fixed set-to-set space therebetween.

The second multiplexing selection unit 821′ is connected to the second sensing and transmitting wires 112. For example, two sets of 30 second sensing and transmitting wires 112 can be simultaneously selected, each set of second sensing and transmitting wires 112 has a fixed line-to-line space and the two sets of second sensing and transmitting wires 111 have a fixed set-to-set space therebetween.

The sensing and computing unit 812′ is connected to the first multiplexing selection unit 811′, the second multiplexing selection unit 821′, the first and second sensing signal control wires 117, 118 of the first and second sensing and transmitting control units 83, 84. When controlling the first and second multiplexing selection units 811′, 821′ to select two sets of first and second sensing and transmitting wires 111, 112, the sensing and computing unit 812′ simultaneously controls to switch on the first and second switches SW1, SW2 to constitute a first sensing and transmitting loop and a second sensing and transmitting loop. The sensing and computing unit 812′ can output an excitation signal S_{E} to one set of the sets of first and second sensing and transmitting wires 111, 112 and receive sensing signals S_{R} from the other set.

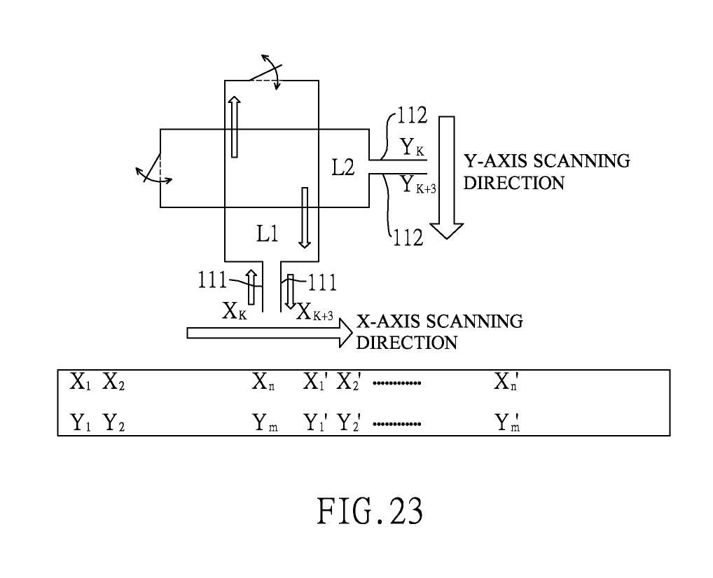

With reference to FIG. 23, when the electromagnetic sensing method is applied to the first sensing and transmitting loop L1 in the applications of case 1 and case 2, two adjacent first sensing and transmitting wires 111 are selectively connected, two non-adjacent first sensing and transmitting wires (X_{K}, X_{K+3}) are selectively connected, or two sets of the first sensing and transmitting wires 111 separated by a fixed set-to-set space are selectively connected. Similarly, two adjacent second sensing and transmitting wires 112 are selectively connected, two non-adjacent second sensing and transmitting wires (Y_{K}, Y_{K+3}) are selectively connected, or two sets of the second sensing and transmitting wires 112 separated by a fixed set-to-set space are selectively connected.

All positions on the flat panel display can be sensed sequentially, or all positions or all sensed information of multiple pixels are sequentially fetched.

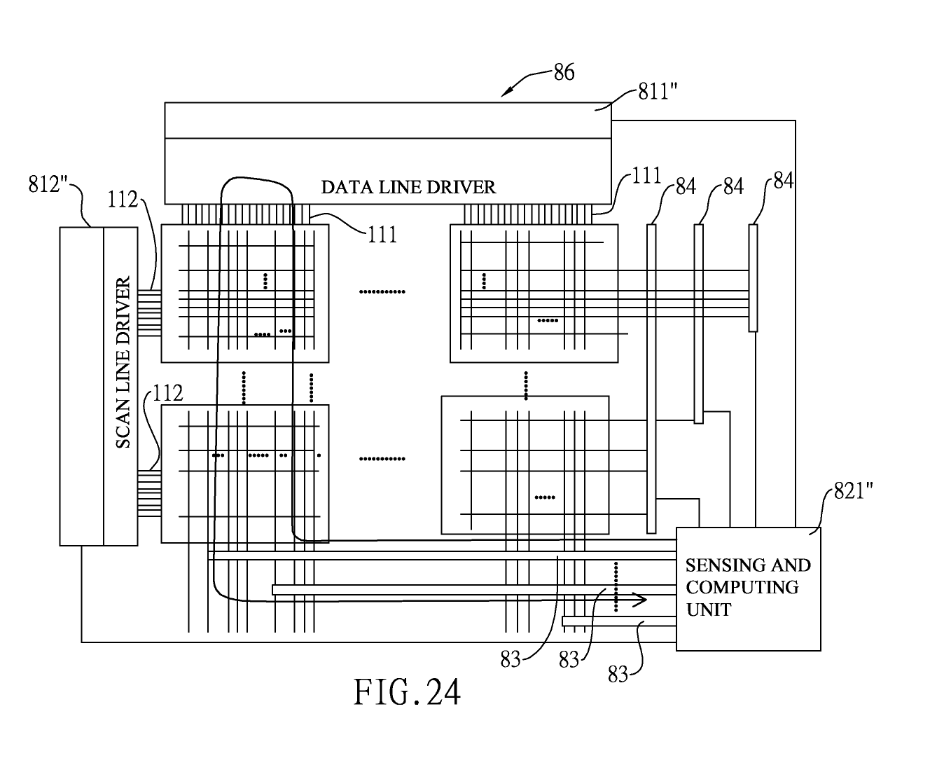

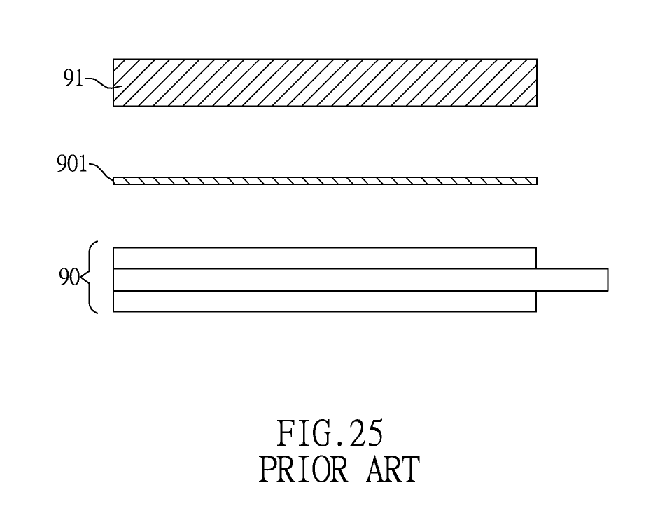

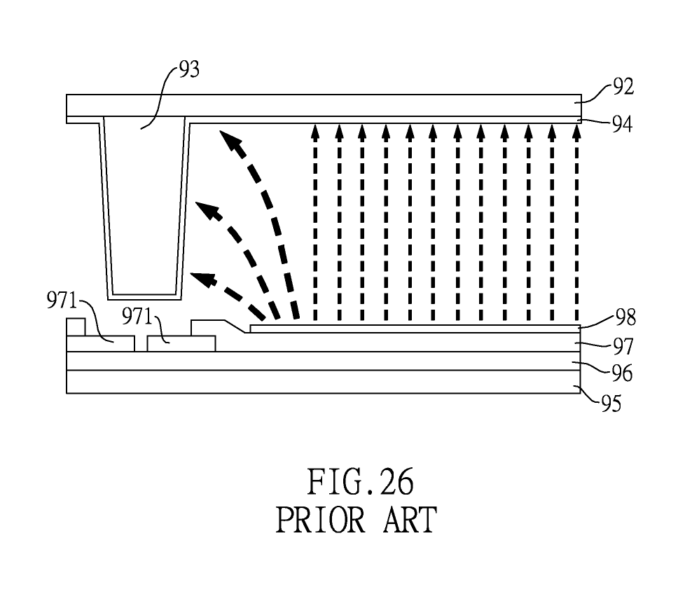

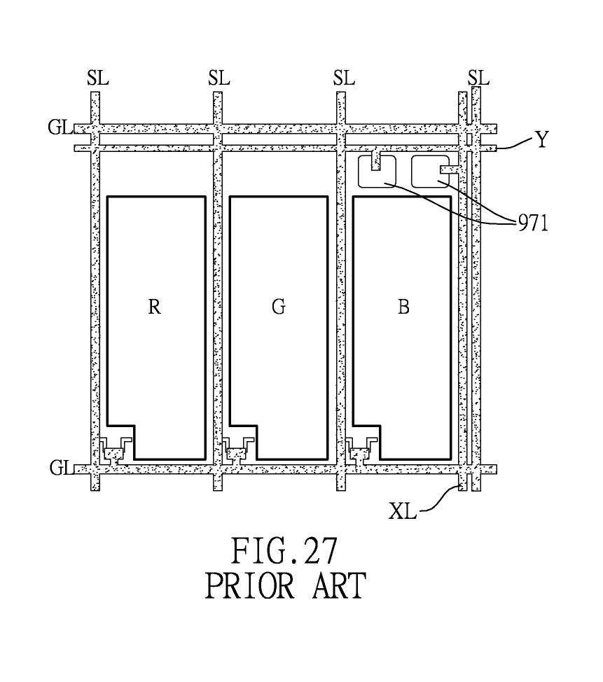

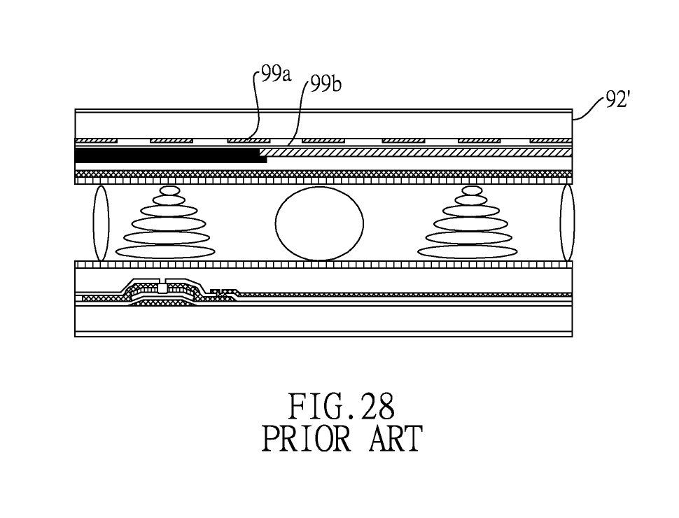

Option 3: With reference to FIG. 24, a sensing and transmitting control unit 86′ has multiple first sensing and transmitting control units 83, multiple second sensing and transmitting control units 84, a first multiplexing selection unit 811″ and a sensing and computing unit 821″.

The first sensing and transmitting control units 83 are respectively connected to multiple sets of first sensing and transmitting wires 111. With further reference to FIG. 22, each first sensing and transmitting control unit 83 has a first sensing and transmitting common wire 115, multiple first switches SW1 and a first sensing signal control wire 117 corresponding to one of the sets of first sensing and transmitting wires 111. Each first switch SW1 is connected to the corresponding first sensing and transmitting wire 111 and the first sensing and transmitting common wire 115. The first sensing signal control wire 117 is connected to the control ends of the first switches SW1 and controls to switch all the first switches SW1.

The second sensing and transmitting control units 84 are respectively connected to multiple sets of second sensing and transmitting wires 112. Each second sensing and transmitting control unit 84 has a second sensing and transmitting common wire 116, multiple second switches SW2 and a second sensing signal control wire 118 corresponding to one of the sets of second sensing and transmitting wires 112. Each second switch SW2 is connected to the corresponding second sensing and transmitting wire 112 and the second sensing and transmitting common wire 116. The second sensing signal control wire 118 is connected to the control ends of the second switches SW2 and controls to switch all the second switches SW2.

The first multiplexing selection unit 811″ is connected to the multiple sets of first sensing and transmitting wires 111. For example, the first multiplexing selection unit 811″ can simultaneously select two sets of 30 first sensing and transmitting wires 111 separated by 100 line-to-line spaces between the two sets.

The second multiplexing selection unit 812″ is connected to the multiple sets of second sensing and transmitting wires 112. For example, the second multiplexing selection unit 812″ can simultaneously select two sets of 30 second sensing and transmitting wires 111 separated by 100 line-to-line spaces between the two sets.

The sensing and computing unit 821″ is connected to the first multiplexing selection unit 811″, the second multiplexing selection unit 812″, the first sensing and transmitting control units 83 and the second sensing and transmitting control units 84. The sensing and computing unit 821″ controls the first multiplexing selection unit 811″ and the second multiplexing selection unit 812″ to select one set of first sensing and transmitting wires 111 and one set of second sensing and transmitting wires 112, controls the first switches SW1 and the second switches SW2 corresponding to the set of first sensing and transmitting wires 111 and the set of second sensing and transmitting wires 112 to switch on so as to constitute a first sensing and transmitting loop and a second sensing and transmitting loop, further outputs an excitation signal to one of the sets of first and second sensing and transmitting wires 111, 112, and receives sensing signals from the other of the sets of first and second sensing and transmitting wires 111, 112. When the current option is applied for capacitive sensing, instead of controlling the first and second switches to switch on, the sensing and computing unit directly selects one set of first sensing and transmitting wires and one set of second sensing and transmitting wires, outputs the excitation signal to one of the sets of first and second sensing and transmitting wires and receives the sensing signals from the other of the sets of first and second sensing and transmitting wires.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A touchable sensing matrix unit on a co-constructed active array substrate having at least one set of conductive wires, the touchable sensing matrix unit comprising:
multiple first sensing and transmitting wires and multiple second sensing and transmitting wires being conductive and cyclic, and respectively corresponding to the at least one set of conductive wires of the co-constructed active array substrate or an improved design using the at least one set of conductive wires of the co-constructed active array substrate, wherein each first sensing and transmitting wire and one of the second sensing and transmitting wires intersect to form an angle; and
an insulation layer mounted between the first sensing and transmitting wires and the second sensing and transmitting wires.

2. The touchable sensing matrix unit as claimed in claim 1, wherein the at least one set of conductive wires of the co-constructed active array substrate are a combination of data lines, scan lines, signal lines, read lines, bias lines, power lines, control lines, partial pixel circuits, common electrodes, partial auxiliary circuits, partial auxiliary pixels, auxiliary wires, compensation circuits, signal control lines for compensation circuit elements formed on the co-constructed active array substrate.

3. The touchable sensing matrix unit as claimed in claim 1, further comprising at least one sensing and transmitting control unit or at least one sensing signal control unit, each one of the at least one sensing and transmitting control unit or at least one sensing signal control unit composed of at least one set of sensing signal control lines, two sets of sensing and transmitting common wires, multiple switches and multiple selection circuit elements to control signal or transmit and collect signals of at least one first sensing and transmitting wire and at least one second sensing and transmitting wire.

4. The touchable sensing matrix unit as claimed in claim 1, further comprising:
a multiplexing selection unit having:
a first multiplexing selection unit connected to and controlling a part of the first sensing and transmitting wires; and
a second multiplexing selection unit connected to and controlling a part of the second sensing and transmitting wires; and
a sensing and computing unit connected to the first multiplexing selection unit, the second multiplexing selection unit and each one of the at least one sensing and transmitting control unit or the at least one sensing and transmitting control unit.

5. The touchable sensing matrix unit as claimed in claim 4, wherein the first multiplexing selection unit and the second multiplexing selection unit select multiple conductive wires on the active array substrate to respectively form the first sensing and transmitting wires and the second sensing and transmitting wires to constitute multiple sensing and transmitting wires or sensing and transmitting wire branches of the touchable sensing matrix unit.

6. The touchable sensing matrix unit as claimed in claim 3, wherein the at least one sensing signal control unit controls the switches or the selection circuit elements through the at least one set of sensing signal control lines thereof to connect to at least one first sensing and transmitting wire and at least one second sensing and transmitting wire through the respective sets of sensing and transmitting common wires to constitute multiple sensing and transmitting wires or sensing and transmitting wire branches of the touchable sensing matrix unit.

7. The touchable sensing matrix unit as claimed in claim 4, wherein the multiplexing selection unit selects one set of at least one first or second sensing and transmitting wire with the same line-to-line space or different line-to-line spaces and another one set of at least one first or second sensing and transmitting wire with the same line-to-line space or different line-to-line spaces, and the sensing and transmitting control unit controls the switches thereof to connect to or disconnect from the set of at least one first or second sensing and transmitting wire and the set of at least one first or second sensing and transmitting wire through the respective sets of sensing and transmitting common wires to constitute multiple sensing and transmitting loops or sensing loops of the touchable sensing matrix unit.

8. The touchable sensing matrix unit as claimed in claim 3, wherein the sensing signal control unit controls the switches thereof through the at least one set of sensing signal control lines to connect to one set of at least one first or second sensing and transmitting wire with the same line-to-line space or different line-to-line spaces and another one set of at least one first or second sensing and transmitting wire with the same line-to-line space or different line-to-line spaces, further connect the set of at least one first or second sensing and transmitting wire and the another set of at least one first or second sensing and transmitting wire to the respective sets of sensing and transmitting common wires and then respectively connect the set of at least one first or second sensing and transmitting wire to the another set of at least one first or second sensing and transmitting wire through an internal loop of the multiplexing selection unit to constitute multiple sensing and transmitting loops or sensing loops of the touchable sensing matrix unit.

9. The touchable sensing matrix unit as claimed in claim 1, wherein the touchable sensing matrix is applicable to capacitive, resistive, pressure, pressure sensitive or pressure deformation sensing signals or wires for detecting, driving and exciting the sensing signals.

10. A touchable sensing active array substrate comprising:
at least one set of conductive wires;
a co-constructed touchable sensing matrix unit having:
multiple first sensing and transmitting wires and multiple second sensing and transmitting wires being conductive and cyclic, and respectively corresponding to the at least one set of conductive wires of the co-constructed active array substrate or an improved design using the at least one set of conductive wires of the co-constructed active array substrate, wherein each first sensing and transmitting wire and one of the second sensing and transmitting wires intersect to form an angle; and
an insulation layer mounted between the first sensing and transmitting wires and the second sensing and transmitting wires; and
at least one sensing and transmitting control unit or at least one sensing signal control unit electrically connected to the co-constructed touchable sensing matrix unit, each one of the at least one sensing and transmitting control unit or at least one sensing signal control unit composed of at least one set of sensing signal control lines, two sets of sensing and transmitting common wires, multiple switches and multiple selection circuit elements to control signals or transmit and collect signals of at least one first sensing and transmitting wire and at least one second sensing and transmitting wire.

11. The touchable sensing active array substrate as claimed in claim 10, wherein a signal of the sensing and transmitting control unit or the sensing signal control unit is transmitted through a sensing and transmitting wire, a sensing and transmitting wire branch or a sensing and transmitting loop.

12. The touchable sensing active array substrate as claimed in claim 10, further comprising:
a multiplexing selection unit having:
a first multiplexing selection unit connected to and controlling a part of the first sensing and transmitting wires; and
a second multiplexing selection unit connected to and controlling a part of the second sensing and transmitting wires; and
a sensing and computing unit connected to the first multiplexing selection unit, the second multiplexing selection unit and each one of the at least one sensing and transmitting control unit or the at least one sensing and transmitting control unit.

13. The touchable sensing active array substrate as claimed in claim 10, wherein the at least one sensing signal control unit controls the switches or the selection circuit elements through the at least one set of sensing signal control lines thereof to connect to at least one first sensing and transmitting wire and at least one second sensing and transmitting wire through the set of sensing and transmitting common wires to constitute multiple sensing and transmitting wires or sensing and transmitting wire branches of the touchable sensing matrix unit.

14. The touchable sensing active array substrate as claimed in claim 10, wherein the first sensing and transmitting wires and the second sensing and transmitting wires output or/and receive sensing signals having physical variations in terms of voltage, current or charge to the touchable sensing matrix unit, and the touchable sensing matrix unit analyzes a variance of the physical variation to determine parameters of touched point, height, touching activation intensity corresponding to the sensing signals having the physical variations.

15. The touchable sensing active array substrate as claimed in claim 13, wherein the multiplexing selection unit selects one set of at least one first or second sensing and transmitting wire with the same line-to-line space or different line-to-line spaces and another one set of at least one first or second sensing and transmitting wire with the same line-to-line space or different line-to-line spaces, and the sensing and transmitting control unit controls the switches thereof to connect to or disconnect from the set of at least one first or second sensing and transmitting wire and the another set of at least one first or second sensing and transmitting wire through the respective sets of sensing and transmitting common wires to constitute multiple sensing and transmitting loops or sensing loops of the active array substrate.

16. The touchable sensing active array substrate as claimed in claim 13, wherein the sensing signal control unit controls the switches thereof through the at least one set of signal sensing control lines to connect to one set of at least one first sensing and transmitting wire with the same line-to-line space or different line-to-line spaces and one set of at least one second sensing and transmitting wire with the same line-to-line space or different line-to-line spaces, and further connects the set of at least one first sensing and transmitting wire and the set of at least one second sensing and transmitting wire to the respective sets of sensing and transmitting common wires and then respectively connect the set of at least one first sensing and transmitting wire to the set of at least one second sensing and transmitting wire through an internal loop of the multiplexing selection unit to constitute multiple sensing and transmitting loops or sensing loops of the active array substrate.

17. The touchable sensing active array substrate as claimed in claim 16, wherein the first sensing and transmitting wires and the second sensing and transmitting wires output or/and receive sensing signals having physical variations in terms of voltage, current or charge to the co-constructed touchable sensing matrix unit, and the touchable sensing matrix unit analyzes a variance of the physical variation to determine parameters of touched point, height, touching activation intensity corresponding to the sensing signals having the physical variations.

18. The touchable sensing active array substrate as claimed in claim 13, wherein the touchable sensing active array substrate is applicable to capacitive, resistive, pressure, pressure sensitive or pressure deformation sensing signal or wires for detecting, driving and exciting the sensing signals.

19. The touchable sensing active array substrate as claimed in claim 13, further comprising a display being one of a liquid crystal display device, an active matrix organic light-emitting diode display device, an electrophoretic display device and an electro-wetting display device.
